(19) United States
(12) Patent Application Publication
(10) Pub. No.: US 2013/0059207 A1
(43) Pub. Date: Mar. 7, 2013

(54) NEGATIVE ELECTRODE ACTIVE MATERIAL

(71) Applicants: Koji Takahata, Toyota-shi (JP); Kaoru Inoue, Hirakata-shi (JP)

(72) Inventors: Koji Takahata, Toyota-shi (JP); Kaoru Inoue, Hirakata-shi (JP)

(21) Appl. No.: 13/698,408

(22) PCT Filed: May 18, 2010
(86) PCT No.: PCT/JP2010/058388

§ 371 Date: Nov. 16, 2012

(51) Int. Cl. H01M 4/587; H01M 10/00

(52) U.S. Cl. 429/231.8; 29/623.1

(57) ABSTRACT

As a negative electrode active material that enables steady production of batteries with excellent low-temperature performance, provided is a composite carbon comprising a low-crystalline carbon material at least partially on surfaces of particles of a high-crystalline carbonaceous substance. The negative electrode active material has a tapped density of 0.9 g/cm³ or smaller and a distribution of R values equal to or rater than 0.2, D₂, of 20% or greater. Here, the R value is a ratio of the D-band intensity I_{D} to the G-band intensity I_{G}, I_{D}/I_{G}, in a 532 nm wavelength Raman spectrum of the negative active material. When a sample of the negative electrode active material is subjected to n (n≧20) times of microscopic Raman analysis at a wavelength of 532 nm and m is the number of times where the R value in the resulting Raman spectrum is equal to or greater than 0.2, the D_{R≧0.2} is a percentage of m to n.

### TECHNICAL FIELD

The present invention relates to a negative electrode active material for batteries such as lithium-ion secondary batteries and others.

### BACKGROUND ART

A lithium-ion secondary battery comprises a positive electrode, a negative electrode, and an electrolyte present between these two electrodes; and charging and discharging are mediated by lithium ions in the electrolyte moving back and forth between the two electrodes. Its negative electrode comprises a negative electrode active material that is able to reversely store and release lithium ions, and as such a negative electrode active material, various pulverized carbon materials are mainly used. Technical literatures relating to a negative electrode material for lithium-ion secondary batteries include Patent Document 1.

### CITATION LIST

### Patent Literature

[Patent Document 1] Japanese Patent Application Publication No. 2004-139743

### SUMMARY OF INVENTION

### Technical Problem

Usage of lithium-ion secondary batteries has been growing in various fields, and because their performances (charge-discharge characteristics, durability, etc.) are significantly affected by the negative electrode performance, improvement and stabilization of negative electrodes have been desired. As a negative electrode active material to form a high-performance negative electrode, for instance, have been investigated composite carbons in which a low-crystalline carbon material is deposited on surfaces of particles of a high-crystalline carbonaceous substance. However, according to the investigation by the present inventor, when such a negative electrode active material is used it has been difficult to steadily produce a targeted performance level (e.g., durability, etc., at a low temperature) and significant deviations have been likely to occur among batteries (typically, among batteries constructed with negative electrode active materials of different lots).

One objective of the present invention is to provide a negative electrode active material that is able to steadily produce batteries with excellent low-temperature performance (reaction resistance at a low temperature, etc.).

### Solution to Problem

The present invention provides a negative electrode active material formed of a composite carbon comprising a low-crystalline carbon material at least partially on surfaces of particles of a high-crystalline carbonaceous substance. This composite carbon has a tapped density of 0.9 g/cm³ or smaller and has a distribution of R values equal to or greater than 0.2, D_{R≧0.2}, of 20% or greater. The R value is a ratio of the D-band intensity I_{D} to the G-band intensity I_{G} (I_{D}/I_{G}) in a Raman spectrum of the negative electrode active material. When microscopic Raman analysis is run at a wavelength of 532 nm a times (n≧20) on a sample of the negative electrode active material and m is the number of times with R values equal to or greater than 0.2 in the resulting Raman spectra, the D_{R≧0.2} is a percentage of m to n, (m/n×100%). According to such a negative electrode active material, because it has a tapped density of 0.9 g/cm³ or smaller as well as a D_{R≧0.2} of 20% or greater, can be steadily produced lithium-ion secondary batteries having excellent low-temperature performance, with which the reaction resistance is reduced at a low temperature (e.g., around −5° C.) and also, rapid charging at a low temperature causes only a small increase in the reaction resistance.

As the tapped density, may be used a value measured in accordance with JIS K1469. The D-band is a Raman peak that appears around 1360 cm⁻¹ due to vibrations of poorly conjugated (continuous) sp²C-sp²C bonds. The G-band is a Raman peak that appears around 1580 cm⁻¹ due to vibrations of highly conjugated sp²C-sp²C bonds. As the respective band intensities, peak-top values modified by setting the base line to zero are used, respectively.

The term low-crystalline carbon material (which hereinafter may be referred to as non-crystalline carbon) refers to a carbon material of low crystallinity, such as amorphous carbons and so on. The term high-crystalline carbonaceous substance (which hereinafter may be referred to as a graphitic substance) refers to a carbon material having a highly-organized layered crystal structure, such as graphite and so on.

In another aspect, the present invention provides a lithium-ion secondary battery that comprises a negative electrode comprising a negative electrode active material disclosed herein, a positive electrode comprising a positive electrode active material, and a non-aqueous electrolyte solution. Such a battery may be less likely to deteriorate even when rapidly charged at a low temperature.

As described above, the lithium-ion secondary battery disclosed herein is less likely to deteriorate even when rapidly charged at a low temperature; and therefore, it is preferable, for instance, as an electric power for a vehicle that may be used in a low temperature environment. Thus, the present invention provides a vehicle comprising a lithium-ion secondary battery disclosed herein. Particularly preferable is a vehicle (e.g., an automobile) comprising such a lithium-ion secondary battery as a power source (typically, a power source of a hybrid vehicle or an electric vehicle).

The art disclosed herein also provides a method for producing a lithium-ion secondary battery; with the method being characterized by that a composite carbon having a tapped density of 0.9 cm³ or smaller and a D_{R≧0.2} of 20% or greater is used as a negative electrode active material It provides a method for producing a lithium-ion secondary battery comprising, for instance, the following steps:

(W) determining the tapped density and the D_{R≧0.2};

(X) judging the acceptability;

(Y) fabricating a negative electrode using an acceptable material; and

(Z) constructing a battery using the negative electrode.

In the step (W), the tapped density and the D_{R≧0.2} may be measured for every subject material, or data of a past measurement may be applied.

### BRIEF DESCRIPTION OF DRAWINGS

FIG. 1 shows a perspective view schematically illustrating the shape of a lithium-ion secondary battery according to one embodiment.

FIG. 2 shows a cross-sectional view taken along the line II-II in FIG. 1.

FIG. 3 shows a graph plotting the initial reaction resistances at −5° C. against the tapped densities with respect to the lithium-ion secondary batteries according to Examples 1 to 10.

FIG. 4 shows a graph plotting the percent increases of reaction resistance after a cycling test at −5° C. against the tapped densities with respect to the lithium-ion secondary batteries according to Examples 1 to 10.

FIG. 5 shows a side view schematically illustrating a vehicle (an automobile) comprising a lithium-ion secondary battery according to the present invention.

FIG. 6 shows a perspective view schematically illustrating the shape of a 18650 lithium-ion battery.

### DESCRIPTION OF EMBODIMENTS

Preferred embodiments of the present invention are described below. Matters necessary to practice this invention other than those specifically referred to in this description may be understood design matters to a person of ordinary skills in the art based on the conventional art in the pertinent field. The present invention can be practiced based on the contents disclosed in this description and common technical knowledge in the subject field.

The negative electrode active material disclosed herein is formed of a composite carbon in which a non-crystalline carbon is deposited at least partially on surfaces of particles of a graphitic substance as a core material. This composite carbon is characterized by having a tapped density of 0.9 g/cm³ or smaller and a D_{R≧0.2} of 20% or greater.

As the tapped density, a value measured in accordance with JIS K1469 is used. In particular, it is determined by mechanically tapping a vessel containing a sample weighing W g of powdered negative electrode active material formed of a composite carbon until it shows little changes in the volume, followed by measuring the volume V cm³ and dividing W by V. Although not particularly limited to, for example, can be used a value measured alter a total of 300 taps at a tapping rate of 31 per minute, using a tapped density analyzer (model “TPM-3”) available from Tsutsui Scientific Instruments Co., Ltd.

When the tapped density of the negative electrode active material is high, the active material's bulk density in the negative electrode becomes greater; and therefore, the energy density (capacity) of the negative electrode can be increased. However, when the bulk density becomes high, the efficiency of Li ion migration (efficiency that a Li ion migrates between particles of the active materials; hereinafter it may be referred to as an efficiency of inter-particle Li-ion migration) through the thickness of the negative electrode active material layer (from the negative electrode surface through the interlace to the current collector) decreases and the rate of the electrochemical reaction in the negative electrode is caused to decrease. When the reaction rate in the negative electrode decreases, especially at a low temperature (e.g., around −5° C.), it becomes difficult to charge at a high rate and rapid charging may cause lithium to precipitate out on the negative electrode surface and the battery may significantly deteriorate.

On the other hand, the electrochemical reaction rate in the negative electrode is mediated not only by the efficiency of inter-particle Li-ion migration, but also by the efficiency of intercalation of Li ions into the active material particles (in between crystal layers) (which hereinafter may be referred to as the intercalation efficiency on particle surfaces). The Li-ion intercalation efficiency varies depending on the crystallinities of surfaces of the respective active material particles. In a composite carbon, of its surfaces, intercalation of Li ions takes place on areas coated with the non-crystalline carbon as well as edge surfaces and exposed broken areas (i.e., low-crystalline areas) of the graphitic substance, but not on areas of exposed basal planes (i.e., high-crystalline areas) of the graphitic substance. Because the tapped density is not indicative of differences in the Li-ion intercalation activities which arise from such variations in the crystallinity, low-temperature performance may vary even among batteries prepared with negative electrode active materials having similar tapped densities. Thus, from the standpoint of reducing performance variations by highly controlling the activity of the negative electrode, it is desirable to use, in addition to the tapped density, an index that is able to detect the crystallinities of surfaces of the active material particles. By evaluating and selecting a negative electrode active material based on both such an index and the tapped density; can be steadily produced lithium-ion secondary batteries combining a desired capacity and desired low-temperature performance.

In the art disclosed herein, as such an index to detect the activities of active material surfaces, the D_{R≧0.2} is used. The D_{R≧0.2} is determined by microscopic Raman analysis. According to microscopic Raman spectroscopy, low-crystalline areas (areas coated with a non-crystalline carbon, edge surfaces (edges of crystals) and broken areas of a graphitic substance) and high-crystalline areas (basal planes (network planes of graphene sheets formed of hexagonal nets of conjugated sp² C's) of a graphitic substance) can be detected as the above-described D-band and the G-band, respectively,

The D_{R≧0.2} is determined, for instance, by carrying out the following steps:

(A) running microscopic Raman analysis at a wavelength of 532 nm n times (n≧20) on a sample of such a negative electrode active material;

(B) with respect to a Raman spectrum obtained in each microscopic Raman analysis run, determining the ratio of its D-band intensity I_{D} to its G-band intensity I_{G}, R(I_{D}/I_{G});

(C) determining the number of analysis runs, m, where the It value was equal to or greater than 0.2; and

(D) as the distribution of K values equal to or greater than 0.2 (D_{R≧0.2}), deter inning the ratio of in to the total number of analysis runs, n, (m/n).

Here, with respect to a single sample, microscopic Raman analysis is run 20 times or mom on randomly-selected parts of the composite carbon that am different every time. This allows to obtain statistical data including variations among particles. Because the data is converted as an index based on the R values of graphitic substances (typically less than 0.2), with respect to a negative electrode active material as a group of particles of a composite carbon, it allows detention of surface activity variations attributed to the surface crystallinity.

The microscopic Raman analysis can he run n times on the same sample using a microscopic laser Raman spectrometer with a high spatial resolution (e.g., 2 μm or smaller). In typical, after completion of each analysis run, the sample is tapped or its orientation is slightly moved for the next run so that different parts are analyzed every time. As the spectrometer, can be used, for instance, model NICOLET ALMEGA XR” available from Thermo Fisher Scientific, Inc., or a similar product. When the spatial resolution is too low (i.e., the minimum distance is too large), variations among particles are less likely to be reflected on the R values and the sensitivity of the evaluation may decrease.

The number of microscopic Raman analysis runs (n) should be 20 or more. The number of analysis runs is preferably 50 or more, or more preferably 75 or more. Although the upper limit of the number of analysis runs is not particularly limited, it can be around 125. When the number of analysis runs is too few, the sensitivity of the results of evaluation on a negative electrode active material may not be sufficient; and therefore, desired negative electrode performance (maximum charging current density; high-temperature storage stability,etc.) may be less likely to be obtained.

In typical, the composite carbon can be formed by depositing and carbonizing a coating material (coating substance) that is able to form non-crystalline carbon films on surfaces of particles of a graphitic substance (core material).

As the core material, can be used various kinds of graphite such as natural graphite, synthetic graphite, etc., processed (pulverized, spherically shaped) into particles (spheres). The core material preferably has an average particle diameter of about 6 μm to 20 μm. As a method for processing various kinds of graphite into particles, a conventional method can be employed without particular limitations.

As the coating material, depending on the method employed for forming a noncrystalline coating, a suitable material to form a carbon film can be selected for use. As the coating formation method, can be suitably employed a conventional method including, for instance, a gas phase method such as the CVD (chemical vapor deposition) method where a coating material in gas phase is vapor-deposited on surfaces of a core material (graphitic substance particles) under an inert gas atmosphere; a liquid phase method where after mixing a core material with a solution prepared by diluting a coating material with a suitable solvent, under an inert gas atmosphere, the coating material is sintered and carbonized; a solid phase method where a core material and a coating material are mixed without a solvent, and then, under an inert gas atmosphere, the coating material is sintered and carbonized; and so on.

As a coating material for the CVD method, can be used a compound (gas) that is able to form carbon films on the core material surfaces when decomposed by heat, plasma, or the like. Examples of such a compound include various hydrocarbon compounds such as aliphatic unsaturated hydrocarbons including ethylene, acetylene, propylene, etc.; aliphatic saturated hydrocarbons including methane, ethane, propane, etc.; aromatic hydrocarbons including benzene, toluene, naphthalene, etc.; and so on. Of these compounds, one kind can be used solely, or a mixed gas of two or more kinds can be used. The temperature, pressure, time, etc., for carrying out the CVD process can be suitably selected in accordance with the kind of coating material to be used and the desired amount of the coating.

As a coating material for a liquid phase method, can be used a compound that is soluble in a variety of solvents and is able to form carbon films on the core material surfaces when thermally decomposed. Preferable examples include pitches such as coal tar pitch, petroleum pitch, wood tar pitch, and so on. These can be used singly or in combination of two or more kinds. The temperature and time for sintering can be suitably selected in accordance with the kind, etc., of the coating material so that now crystalline carbon films are formed. In typical, sintering may be carried out in a range of about 800° C. to 1600° C., for 2 to 3 hours.

As a coating material for a solid phase method, can be used one kind, or two or more kinds of the same coating materials as those for the liquid phase method. The temperature and time for sintering may be suitably selected in accordance with the kind of coating material. For instance, they can be in the same ranges as for the liquid phase method.

When employing any coating method, where necessary, various additives (e.g., additives effective in formation of a non-crystalline carbon from the coating material, or others) can be added to the coating material.

The amount of non-crystalline carbon coating in the composite carbon can be about 0.5 to 8% by mass (preferably 2 to 6% by mass). When the amount of coating is too small, the properties (low self-discharge, etc.) of the non-crystalline carbon may not be sufficiently reflected in the negative electrode performance. When the amount of coating is too large, because Li ions move through complex pathways inside the non-crystalline carbon, the rate of lithium ion diffusion may slow down in the non-crystalline coating, thereby decreasing the rate of the electrochemical reaction at the negative electrode.

The mixing ratio of the core material to the coating material can be suitably selected in accordance with the coating method to be applied so that the amount of coating after appropriate work-up processes (removal of impurities and unreacted starting materials, etc.) is in the range described above.

As the composite carbon disclosed herein, can be used a composite carbon having a tapped density of about 0.9 g/cm³ or smaller and a D_{R≧0.2} of 20% or greater.

When the tapped density is excessively high, the reaction resistance may be significantly increased by rapid charge-discharge cycles at a low temperature and the battery may deteriorate. When the tapped density is excessively low, the negative electrode volume required to achieve a prescribed capacity may significantly increase. Although the lower limit of the tapped density is not particularly limited, from the standpoint of increasing the energy density by suppressing an increase in the negative electrode volume, it is preferable to be about 0.4 g/cm³ or grater; or from the standpoint of keeping the per-batch productivity in mixing negative electrode materials, it is preferable to be 0.5 g/cm³ or greater

On the other hand, when the D_{R≧0.2} is too small, the initial reaction resistance may become higher. The upper limit of D_{R≧0.2} is not particularly limited, it is usually about 95% or smaller.

The negative electrode active material (alter coating) may have a specific surface area of for instance, about 1 m²/g to 10 m²/g. When the specific surface area is too small, sufficient current densities may not be obtained when charging and discharging. When the specific surface area is too large, the battery capacity may significantly decrease due to an increased irreversible capacity and so on. As the specific surface area, can be used a value measured by the nitrogen adsorption method.

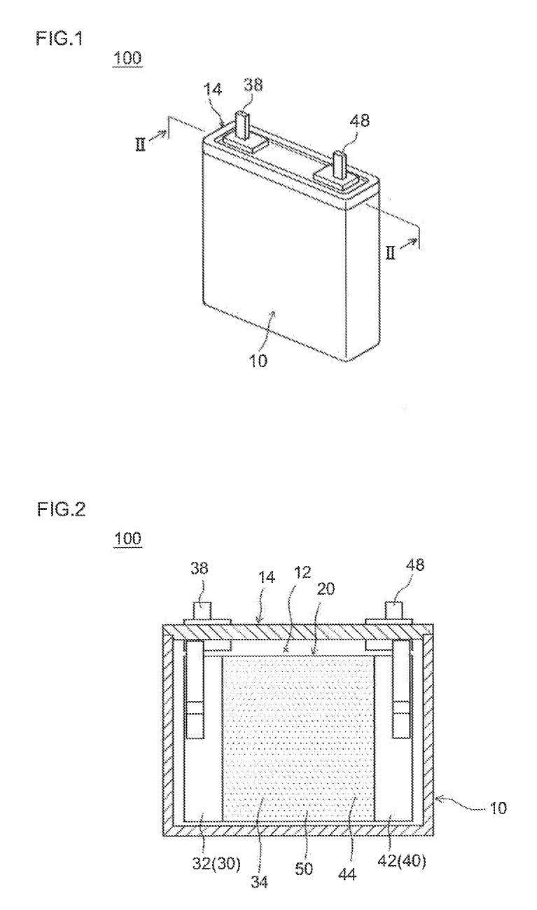

The present invention provides a lithium-ion secondary battery characterized by comprising a negative electrode containing a negative electrode active material disclosed herein. An embodiment of such a lithium-ion secondary battery is described in detail with an example of a lithium-ion secondary battery 100 (FIG. 1) having a configuration where an electrode body and a non-aqueous electrolyte solution are placed in a square battery ease while the art disclosed herein is not limited to such an embodiment. In other words, the shape of the lithium-ion secondary battery disclosed herein is not particularly limited, and the materials, shapes, sizes, etc., of components such as the battery case, electrode body, etc., can be suitably selected in accordance with its intended use and capacity. For example, the battery case may have a cubic, flattened, cylindrical, or other shape. In the following drawings, all members and sites providing the same effect are indicated by the same reference numerals, and redundant descriptions may be omitted or abbreviated. Moreover, the dimensional relationships (of length, width, thickness, etc.) in each drawing do not represent actual dimensional relationships.

As shown in FIG. 1 and FIG. 2, a lithium-ion secondary battery 100 can be constructed by placing a wound electrode body 20 along with an electrolyte solution not shown in the drawing via an opening 12 into a flat box-shaped battery case 10 suitable for the shape of the electrode body 20, and closing the opening 12 of the case 10 with a lid 14. The lid 14 has a positive terminal 38 and a negative terminal 48 for connection to the outside, with the terminals partially extending out from the surface of the lid 14.

The electrode body 20 is formed into a flattened shape by overlaying and rolling up a positive electrode sheet 30 in which a positive electrode active material layer 34 is formed on the surface of a long sheet of a positive current collector 32 and a negative electrode sheet 40 in which a negative electrode active material layer 44 is formed on a long sheet of a negative current collector 42 along with two long sheets of separators 50, and laterally compressing the resulting wound body.

The positive electrode sheet 30 is formed to expose the positive current collector 32 on an edge along the sheet length, where the positive electrode active material layer 34 is not provided (or has been removed). Similarly, the negative electrode sheet 40 to be wound is formed to expose the negative current collector 42 on an edge along the sheet length, where the negative electrode active material is not provided (or has been removed). The positive terminal 38 is joined to the exposed edge of the positive current collector 32 and the negative terminal 48 is joined to the exposed edge of the negative current collector 42, respectively, to form electrical connections with the positive electrode sheet 30 and the negative electrode sheet 40 of the flattened wound electrode body 20. The positive and negative terminals 38 and 48 can be joined to their respective positive and negative current collectors 32 and 42, for example, by ultrasonic welding, resistance welding, and so on.

The negative electrode active material layer 44 can be formed, for instance, by applying to the negative current collector 42 a paste or slurry composition (negative electrode material mixture) obtained by dispersing in a suitable solvent a negative electrode active material disclosed herein as well as a binder, etc., and digging the applied composition. Although the amount of the negative electrode active material contained in the negative electrode material mixture is not particularly limited, it is preferably about 90 to 99% by mass, or more preferably 95 to 99% by mass.

As the binder, a suitable one can be selected for use from various polymers. One kind can be used solely, or two or more kinds can be used in combination.

Examples include water-soluble polymers such as carboxymethyl cellulose (CMC), methyl cellulose (MC), cellulose acetate phthalate (CAP), hydroxypropyl methylcellulose (HPMC), hydroxypropyl methylcellulose phthalate (HPMCP), polyvinyl alcohols (PVA), etc.; fluorine containing resins such as polytetrafluoroethylene (PTFE), tetralluoroethylene-perfluoroalkyl vinyl ether copolymers (PEA), tetrafluoroethylene-hexafluoropropylene copolymers (FEP), ethylene-tetrafluoroethylene copolymers (EMI), etc.; water-dispersible polymers such as vinyl acetate copolymers, styrene butadiene block copolymers (SBR), acrylic acid-modified SBR resins (SBR-based latexes), rubbers (gum arabic, etc,), etc.; oil-soluble polymers such as polyvinylidene fluoride (PVDF), polyvinylidene chloride (PVDC), polyethylene oxide (PEO), polypropylene oxide (PPO), polyethylene oxide-propylene oxide copolymers (PEO-PPO), etc.; and so on.

The amount of the binder added can be suitably selected in accordance with the type and amount of the negative electrode active material. For example, it can be about 1 to 5% by mass of the negative electrode material mixture.

As the negative current collector 42, can be preferably used a conductive material formed of a metal having good conductivity For instance, copper or an alloy containing copper as the primary component can be used. The shape of the negative current collector 42 is not particularly limited as it may vary in accordance with the shape, etc., of the lithium-ion secondary battery, and it may have a variety of shapes such as a rod, plate, sheet, foil, mesh, and so on. In the present embodiment, a copper sheet is used as the negative current collector 42 and can be preferably used in a lithium-ion secondary battery 100 comprising a wound electrode body 20. In such an embodiment, for example, a copper sheet having a thickness of about 6 μm to 30 μm can be preferably used.

The positive electrode active material layer 34 can be formed, for instance, by applying to the positive current collector 32 a paste or slurry composition (positive electrode material mixture) obtained by dispersing in a suitable solvent a positive electrode active material along with a conductive material, a binder, etc, as necessary and by drying the composition.

As the positive electrode active material, a positive electrode material that is able to store and release lithium is used, and one kind, or two or more kinds of substances (e.g., layered oxides and spinel oxides) conventionally used in lithium-ion secondary batteries can be used without particular limitations. Examples include lithium-containing composite oxides such as lithium-nickel-based composite oxides, lithium-cobalt-based composite oxides, lithium-manganese-based composite oxides, lithium-magnesium-based composite oxides, and the like.

Herein, the scope of the lithium-nickel-based composite oxide encompasses oxides containing lithium (Li) and nickel (Ni) as constituent metal elements as well as oxides containing as constituent metal elements, in addition to lithium and nickel, at least one other kind of metal element (i.e., a transition metal element and/or a main group metal element other than Li and Ni) at a ratio roughly equal to or less than nickel (typically at a ratio less than nickel) based on the number of atoms. The metal element other than Li and Ni can be, for instance, one, two or more kinds of metal elements selected from a group consisting of cobalt (Co), aluminum (Al), manganese (Mn), Chromium (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La), and cerium (Ce). It is noted that the same applies also to the scopes of the lithium-cobalt-based composite oxide, the lithium-manganese-based composite oxide, and the lithium-magnesium-based composite oxide.

Alternatively, as the positive electrode active material, can be used an olivine lithium phosphate represented by the general formula LiMPO₄ (wherein M is at least one or more kinds of elements selected from Co, Ni, Mn and Fe; e.g., LiFePO₄, LiMnPO₄).

The amount of the positive electrode active material contained in the positive electrode material mixture can be, for example, about 80 to 95% by mass.

As the conductive material, can be preferably used a powdered conductive material such as carbon powder, carbon fibers, and so on. As the carbon powder, various kinds of carbon black such as acetylene Wad:, furnace black, Ketjen black, graphite powder and the like are preferred. One kind of conductive material can be used solely, or two or more kinds can be used in combination.

The amount ofthe conductive material contained in the positive electrode material mixture may be suitably selected in accordance with the kind and amount of the positive electrode active material, and for instance, it can be about 4 to 15% by mass.

As the binder, of those listed early for the negative electrode, can be used one kind alone, or two or more kinds in combination. The amount of the binder added can he suitably selected in accordance with the kind and amount of the positive electrode active material, and for instance, it can be about 1 to 5% by mass of the positive electrode material mixture.

As the positive current collector 32, can be preferably used a conductive material formed of a metal having good conductivity. For example, can be used aluminum or an alloy containing aluminum as the primary component The shape of the positive current collector 32 is not particularly limited as it may vary in accordance with the shape, etc., of the lithium-ion secondary battery, and it may have a variety of shapes such as a rod, plate, sheet, foil, mesh, and so on. In the present embodiment, an aluminum sheet is used as the positive current collector 32 and can be preferably used in as lithium-ion secondary battery 100 comprising a wound electrode body 20. In such an embodiment, for example, an aluminum sheet having a thickness of about 10 μm to 30 μm can be preferably used.

The non-aqueous electrolyte solution comprises a supporting salt in a non-aqueous solvent (organic solvent). As the supporting salt, a lithium salt used as a supporting salt in general lithium-ion secondary batteries can be suitably selected for use. Examples of such a lithium salt include LiPF₆, LiBF₄, LiClO₄, LiAsF₆, Li(CF₃SO₂)₂N, LiCF₃SO₃, and the like. One kind of such a supporting salt can be used solely, or two or more kinds can he used in combination. LiPF₆ can be given as an especially preferable example. It is preferable to prepare the non-aqueous electrolyte solution to have a supporting salt concentration within a range of, fur instance, 0.7 mol/L to 13 mol/L.

As the non-aqueous solvent, an organic solvent used in general lithium-ion secondary batteries can be suitably selected for use. Examples of especially preferable non -aqueous solvents include carbonates such as ethylene carbonate (EC), dimethyl carbonate (DMC), ethyl methyl carbonate (EMC), diethyl carbonate (DEC), vinylene carbonate (VC), and propylene carbonate (PC), and so on. Of these organic solvents, one kind can be used solely, or two or more kinds can be used in combination. For example, a mixture of EC, DMC, and EMC, or a mixture of these and VC can be preferably used.

The separator 50 is a sheet placed between the positive electrode sheet 30 and the negative electrode 40 so as to be in contact with both the positive electrode active material layer 34 of the positive electrode sheet 30 and the negative electrode active material layer 44 of the negative electrode sheet 40. It functions to prevent a short circuit associated with direct contact between the two electrode active material layers 34 and 44 on the positive electrode sheet 30 and the negative electrode sheet 40. It also functions to form conductive paths (conductive pathways) between the electrodes, with the pores of the separator 50 having been impregnated with the electrolyte solution. As such a separator 50, a conventional separator can be used without particular limitations. For example, a porous sheet of a resin (micro-porous resin sheet) can be preferably used. A porous sheet of a polyolefin resin such as polyethylene (PE), polypropylene (PP), polystyrene, etc, is preferred. In particular; can be used preferably a PE sheet, a PP sheet, a multi-layer sheet having overlaid PE and PP layers, or the like. The thickness of the separator is preferably set within a range of about 10 μm to 40 μm, for example.

Several embodiments relevant to the present invention are described below although this is not to limit the present invention to these embodiments. In the following explanation, the terms “parts” and “%”. are based on the mass unless specifically stated otherwise.

### EXAMPLE 1

Graphite particles (core material) were subjected to a CVD process to obtain a negative electrode active material formed of a composite carbon having a coating amount of 2% and a tapped density of 0.43 g/cm³.

### EXAMPLE 2

Graphite particles (core material) were subjected to a CVD process to obtain a negative electrode active material formed of a composite carbon having a coating amount of 2% and a tapped density of 0.52 g/cm³.

### EXAMPLE 3

Graphite particles (core material) were subjected to a CVD process to obtain a negative electrode active material formed of a composite carbon having a coating amount of 2% and a tapped density of 0.61 g/cm³.

### EXAMPLE 4

Graphite particles (core material) were subjected to a CVD process to obtain a negative electrode active material formed of a composite carbon having a coating amount of 2% and a tapped density of 0.69 g/cm³.

### EXAMPLE 5

Graphite particles (core material) were subjected to a CVD process to obtain a negative electrode active material formed of a composite carbon having a coating amount of 2% and a tapped density of 0.82 g/cm³.

### EXAMPLE 6

Graphite particles (core material) were subjected to a CVD process to obtain a negative electrode active material formed of a composite carbon having a coating amount of 2% and a tapped density of 0.85 g/cm³.

### EXAMPLE 7

Graphite particles (core material) were subjected to a CVD process to obtain a negative electrode active material formed of a composite carbon having a coating amount of 2% and a tapped density of 0.91 g/cm³.

### EXAMPLE 8

Graphite particles (core material) were subjected to a CVD process to obtain a negative electrode active material formed of a composite carbon having a coating amount of 2% and a tapped density of 1.00 g/cm³.

### EXAMPLE 9

Graphite particles (core material) were subjected to a CVD process to obtain a negative electrode active material formed of a composite carbon having a coating amount of 2% and a tapped density of 1.01 g/cm³.

### EXAMPLE 10

Graphite particles (core material) were subjected to a CVD process to obtain a negative electrode active material formed of a composite carbon having a coating amount of 2% and a tapped density of 1.04 g/cm³.

The following evaluations and measurements were carried out on the respective negative electrode active materials of Examples 1 to 10.

### [Tapped Density]

With respect to an approximately 30 g of a sample of each negative electrode active material, the tapped density was measured after a total of 300 taps at a tapping rate of 31 per minute, using a tapped density analyzer (model “TPM-3”) available from Tsutsui Scientific Instruments Co., Ltd.

### [Microscopic Raman Analysis]

A 0.1 mg sample of the negative electrode active material of each Example was subjected to 125 runs of microscopic Raman analysis using a microscopic laser Raman system (model “Nicolet Ahnega XR” available from Thermo Fisher Scientific, Inc.) at a wavelength of 532 nm for a measurement time of 30 seconds, at 2 μm resolution and 100% laser output; and the R value for each run was determined, As the D_{R≧0.2}, was calculated the percentage of the number of runs where the R value was equal to or greater than 0.2 relative to the total number of analysis runs.

### [18650 Battery]

With the respective negative electrode active materials of Examples 1 to 10, according to the following procedures, were fabricated 18650 batteries (in cylindrical shape of 18 mm diameter, 65 mm high).

As a negative electrode material mixture, a negative electrode active material, SBR and CMC were mixed at a mass ratio of 98:1:1 and NV of 45% ion-exchanged water to prepare a sluny composition. This negative electrode material mixture was applied to each face of a 10 μm thick copper foil strip so that the total amount applied to both faces was 8 mg/cm². This was dried and then pressed to prepare a negative electrode sheet having a total thickness of about 65 μm.

As a positive electrode material mixture, LiNi_{1/3}Co_{1/3}Mn_{1/3}O₂, acetylene black (AB) and polyvinylidene fluoride (PVDF) were mixed at a mass ratio of 85:10:5 and NV of 50% in N-methyl-2-pyrrolidone (NMP) to prepare a shiny composition. This composition was applied to each face of a 15 μm thick aluminum foil strip so that the total amount applied to both faces was 16.7 mg/cm². This was dried and then pressed to prepare a positive electrode sheet having a total thickness of about 110 μm.

As a non-aqueous electrolyte solution, was prepared a 1 mol/L (1 M) LiPF₆ solution, using a mixed solvent containing EC, DMC, and EMC at a volume ratio of 1:1:1.

The positive elect de sheet and the negative electrode sheet were overlaid along with two long porous polyethylene sheets having a thickness of 84 μm and the resulting laminate was tolled along the length. The resulting wound electrode body was placed into a cylindrical case along with the non-aqueous electrolyte solution, and the case was sealed to construct a 18650 battery 200 (FIG. 6) having a capacity of 250 mAh.

### [Conditioning Process]

Each battery was subjected to constant-current (CC) charging at a rate of 1/10 C for 3 hours followed by three cycles of charging to 4.1 V at a rate of 1/3 C and discharging to 3.0 V at a rate of 1/3 C. One C indicates an amount of current to charge the battery in one hour to its full capacity (Ah) calculated from the theoretical capacity ofthe positive electrode.

Each conditioned battery was subjected to the following measurements.

### [Low-Temperature Reaction Resistance]

Before and after carrying out the cycling test described below (before conducting the first cycle and after completing the 500th cycle), the impedance was measured to determine the initial reaction resistance (mΩ) and the reaction resistance after 500 cycles at −5° C. More specifically, each battery adjusted to a SOC of 60% at a rate of 1 C was subjected to impedance measurement at a. temperature of −5° C. over a frequencies from 3 mHz to 10 kHz, at an alternating-current voltage (oscillation) of 5 mV. From the resulting Cole-Cole plot (arc portion), the respective reaction resistance (mΩ) was determined. As the percent increase of reaction resistance after the cycling, was determined the percentage of the increase in the reaction resistance (the difference between the post-cycling reaction resistance and the initial reaction resistance) to the initial reaction resistance.

### [Cycling Test]

Each battery after the initial reaction resistance measurement was brought to a SOC of 80%, and at room temperature (23° C.), it was CC discharged to a SOC of 0% at a rate of 1/3C, and at the same time, the discharge capacity was measured as the initial capacity The battery was then subjected to a cycle of charging at a rate of 10 C for 10 seconds followed by a 5-second break followed by discharging at a rate of 1 C for 100 seconds followed by a 10-minute break, and this cycle was repeated 500 times. When the 500th cycle was completed, the post-cycling reaction resistance was measured as described above.

With respect to the negative electrode active materials and batteries of Examples 1 to 10, the results of the measurements are shown in Table 1.

TABLE 1

| | Tapped | | Reaction resistance | | Increase of |
|---|---|---|---|---|---|
| | density | D_{R≧0.2} | (mΩ) | | resistance |
| Example | (g/cm³) | (%) | Initial | Post-cycling | (%) |
| 1 | 0.43 | 23 | 152.9 | 154.5 | 1.04 |
| 2 | 0.52 | 25 | 153.4 | 155 | 1.04 |
| 3 | 0.61 | 32 | 155.3 | 157 | 1.07 |
| 4 | 0.69 | 36 | 160.4 | 162.1 | 1.1 |
| 5 | 0.82 | 59 | 168.4 | 170.2 | 1.1 |
| 6 | 0.85 | 19 | 208 | 210.7 | 1.3 |
| 7 | 0.91 | 48 | 195 | 198.3 | 1.7 |
| 8 | 1.00 | 35 | 221.5 | 228.1 | 3.0 |
| 9 | 1.01 | 13 | 253.2 | 273.4 | 8 |
| 10 | 1.04 | 95 | 227.3 | 244.3 | 7.5 |

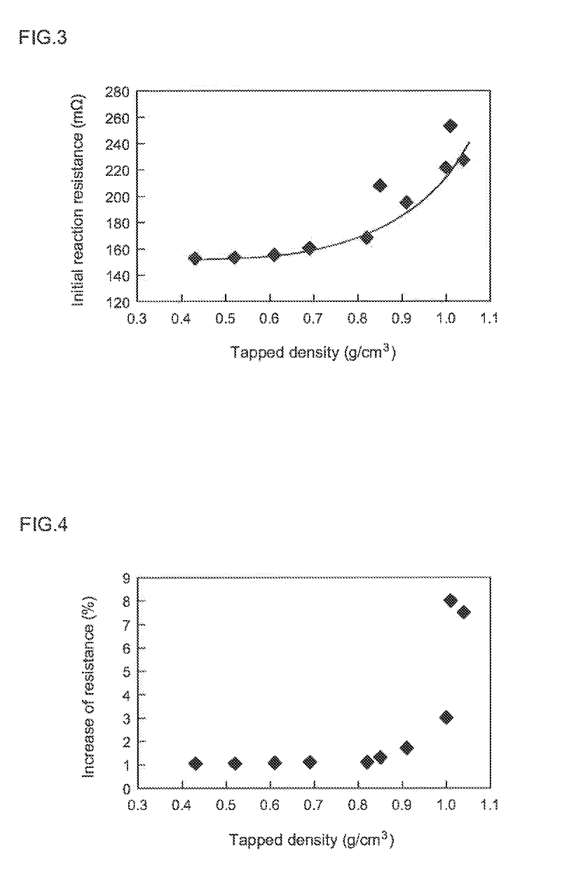

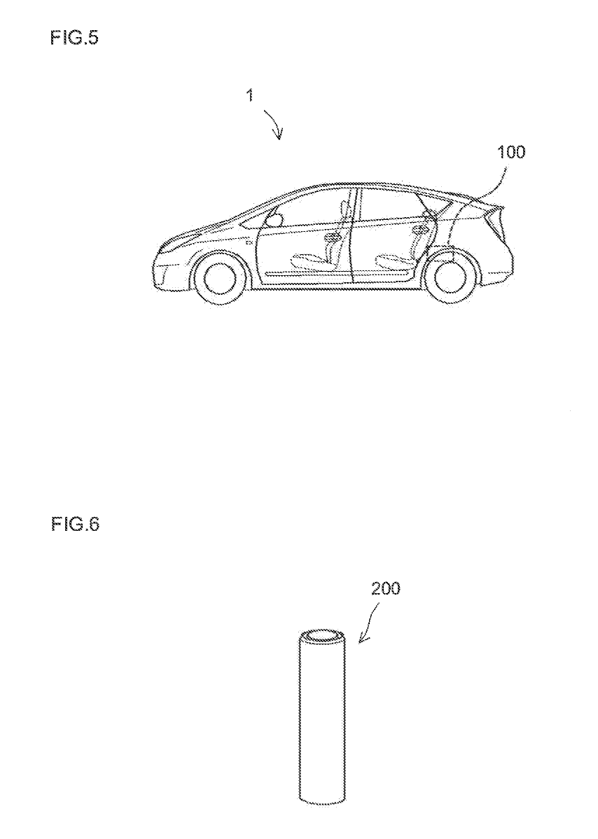

As shown in Table 1 and FIG. 3, although the initial reaction resistance at −5° C. tended to increase as the tapped density increased, deviations were found. For example, in comparison of Example 6 having a D_{R≧0.2} of less than 20% to Examples 5 and 7 each having a D_{R≧0.2} of 20% or greater, on the contraiy to the tapped density of the negative electrode active material of Example 6 being in between those of Examples 5 and 7, the initial and post-cycling reaction resistances of Example 6 were higher by about 40 mΩ than Example 5 and higher by 12 mm to 13 mm than Example 7. Similarly, in comparison of Example 9 having a D_{R≧0.2} of less than 20% to Example 8 having a D_{R≧0.2} of 20% or greater while having approximately the same tapped density, the initial reaction resistance of Example 9 was higher by at least 30 mΩ and its post-cycling reaction resistance was higher by 45 mΩ. Moreover, as shown in FIG. 4, in comparison of Examples 8 and 9, was observed a significant variation in the performance such that the percent increase of resistance of Example 9 was about three times that of Example 8.

As shown in Table 1 as well as FIGS. 3 and 4, batteries of Examples 1 to 5 each prepared with a negative electrode active material having a tapped density of 0.9 g/cm³ or smaller and a D_{R≧0.2} of 20% or geater, all exhibited low initial reaction resistances of less than 200 mΩ, and even after subjected to 500 cycles of a charge-discharge cycle at very high charging and discharging rates in an environment at a temperature as low as −5° C., they exhibited great low-temperature performance with the percent increase of resistance being at most 1.1%.

Although specific embodiments of the present invention have been described in detail above, these are merely for illustrations and do not limit the scope of the claims. The art according to the claims includes various modifications and changes of the specific embodiments illustrated above.

### REFERENCE SIGNS LIST

1 vehicle
20 wound electrode body
30 positive electrode sheet
32 positive current collector
34 positive electrode active material layer
38 positive terminal
40 negative electrode sheet
42 negative current collector
44 negative electrode active material layer
48 negative terminal
50 separator
100, 200 lithium-ion secondary battery

1. A negative electrode active material for a lithium-ion secondary battery,
wherein the negative electrode active material is formed of a composite carbon comprising a low-crystalline carbon material at least partially on surfaces of particles of a high-crystalline carbonaceous substance, with the negative electrode active material satisfying the following conditions:
having a tapped density of 0.43 g/cm³ to 0.69 g/cm³ or smaller; and
having a distribution of R values equal to or greater than 0.2, D_{R≧0.2}, of 20% or greater,
wherein the R value is a ratio of a D-band intensity I_{D} to a G-band intensity I_{G}, I_{D}/I_{G}, in a 532 nm wavelength Raman spectrum of the negative electrode active material; and when a sample of the negative electrode active material is subjected to n (n=125) times of microscopic Raman analysis at a wavelength of 532 nm and m is the number of times where the R value in the resulting Raman spectrum is equal to or greater than 0.2, the D_{R≧0.2} is a percentage of m to n, and
the composite carbon is formed by depositing and carbonizing a coating material to form films of a non-crystalline carbon on surfaces of particles of a graphitic substance, and the coating amount of the non-crystalline carbon in the composite carbon is 2 to 6% by mass.

2. A lithium-ion secondary battery comprising a negative electrode comprising the negative electrode active material according to claim 1, a positive electrode comprising a positive electrode active material, and a non-aqueous electrolyte solution.

3. A vehicle comprising the lithium-ion secondary battery according to claim 2.

4. A method for producing a lithium-ion secondary battery, comprising the step of using the negative electrode active material formed of the composite carbon according to claim 1.

5. The method according to claim 4, comprising the steps of:
determining a tapped density and a D_{R≧0.2} of the negative electrode active material;
judging an acceptability of the negative electrode active material;
fabricating a negative electrode using an acceptable material of the negative electrode active material; and
constructing the lithium-ion secondary battery using the negative electrode.
